(19) United States
(12) Patent Application Publication
(10) Pub. No.: US 2015/0047447 A1
(43) Pub. Date: Feb. 19, 2015

(54) GUIDE PLATE MOUNTING STRUCTURE OF FUEL PUMP

(71) Applicants: Kia Motors Corporation, Seoul (KR); Hyundai Motor Company, Seoul (KR)

(72) Inventor: Jae Kyu LEE, Hwaseong-si (KR)

(73) Assignees: Kia Motors Corporation, Seoul (KR); Hyundai Motor Company, Seoul (KR)

(21) Appl. No.: 14/094,587

(22) Filed: Dec. 2, 2013

(30) Foreign Application Priority Data
Aug. 13, 2013 (KR) 10-2013-0095912

(51) Int. Cl. F16H 57/025

(52) U.S. Cl. CPC F16H 57/025
USPC 74/434

(57) ABSTRACT

A guide plate mounting structure of a fuel pump, the guide plate mounting structure may include a fuel pump having a housing, a driving shaft protrudedly formed from the housing to the outside of the fuel pump, a block mounted onto an outer peripheral surface of the housing of the fuel pump, a guide plate having a first through hole formed at a center thereof and being positioned at an end of the block, and a fuel pump gear having a second through hole formed at a center thereof and being mounted to the driving shaft of the fuel pump through the second through hole, and a rim formed on an end surface of the fuel pump gear so as to be inserted into a first end surface of the guide plate.

### CROSS-REFERENCE TO RELATED APPLICATION

The present application claims priority to Korean Patent Application No. 10-2013-0095912, filed on Aug. 13, 2013, the entire contents of which is incorporated herein for all purposes by this reference.

### BACKGROUND OF THE INVENTION

1. Field of the invention

The present invention relates to a guide plate mounting structure of a fuel pump, and more particularly, to a guide plate mounting structure of a fuel pump for decreasing noise caused by shaft deformation after a fuel pump gear is mounted in the fuel pump.

2. Description of Related Art

Generally, a fuel pump may be mounted in a fuel tank of a vehicle so as to effective supply fuel sucked from the fuel tank to an engine.

In a fuel pump according to the related art a high pressure pump sprocket 2 is connected to a crank sprocket 1 of a diesel engine so as to be integrally rotated through a timing chain 3 and a cam sprocket 4 is connected to the high pressure pump sprocket 2 so as to be integrally rotated through a timing chain 3, as shown in FIG. 1.

Here, examples of the timing chain 3 include a roller chain, a bush chain, and a silence chain. However, the roller chain is disadvantageous in an aspect of durability and the silence chain is disadvantageous in an aspect of cost. Therefore, the bush chain has typically been used.

However, according to the related art, noise caused by engaging the chain with the sprocket at the time of driving the engine is largely increased by the shaft deformation caused by chain tension, thereby decreasing noise, vibration and harshness (NVH) performance of a vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a guide plate mounting structure of a fuel pump, and more particularly, a guide plate mounting structure of a fuel pump for decreasing noise caused by shaft deformation after a fuel pump gear is mounted in the fuel pump.

In an aspect of the present invention, a guide plate mounting structure of a fuel pump, may include a fuel pump having a housing, a driving shaft protrudedly formed from the housing to the outside of the fuel pump, a block mounted onto an outer peripheral surface of the housing of the fuel pump, a guide plate having a first through hole formed at a center thereof and being positioned at an end of the block, and a fuel pump gear having a second through hole formed at a center thereof and being mounted to the driving shaft of the fuel pump through the second through hole, and a rim formed on an end surface of the fuel pump gear so as to be inserted into a first end surface of the guide plate.

The first through hole of the guide plate may have a step formed along an inner peripheral surface thereof and the step of the first through hole and the first end surface of the guide plate may have a circular insertion groove formed therebetween, such that the rim of the fuel pump gear is inserted into the insertion groove.

The guide plate may include a third through hole, wherein the guide plate is connected to the block by a coupling member passing through the third through hole and being coupled to the block.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a fuel pump for a vehicle according to the related art.

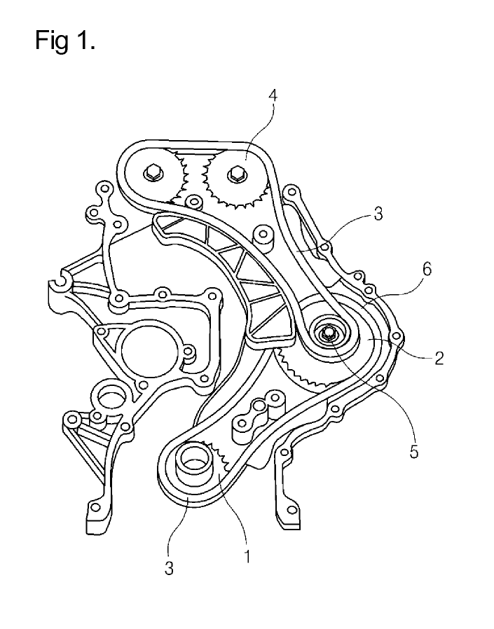

FIG. 2 is a view showing a guide plate mounting structure of a fuel pump according to an exemplary embodiment of the present invention.

FIG. 3 is a cross-sectional view showing the guide plate mounting structure of the fuel pump according to the exemplary embodiment of the present invention.

FIG. 4 is a view showing a guide plate of the guide plate mounting structure of the fuel pump according to the exemplary embodiment of the present invention.

FIG. 5 is a view showing a fuel pump gear of the guide plate mounting structure of the fuel pump according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described in detail with reference to the accompanying drawings.

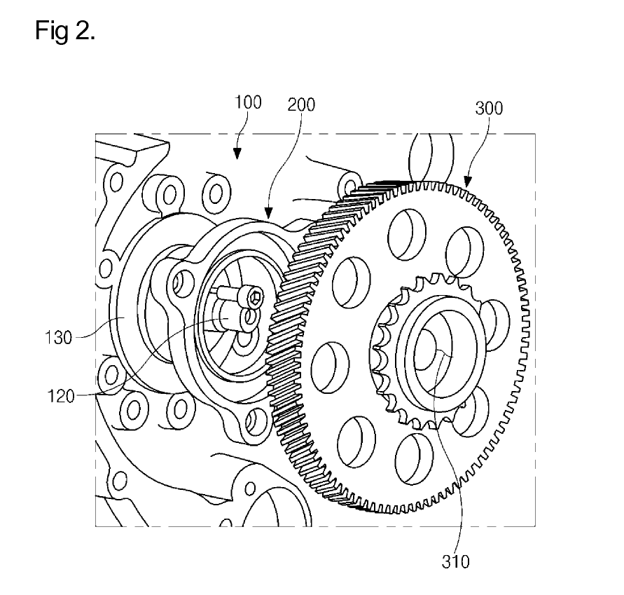

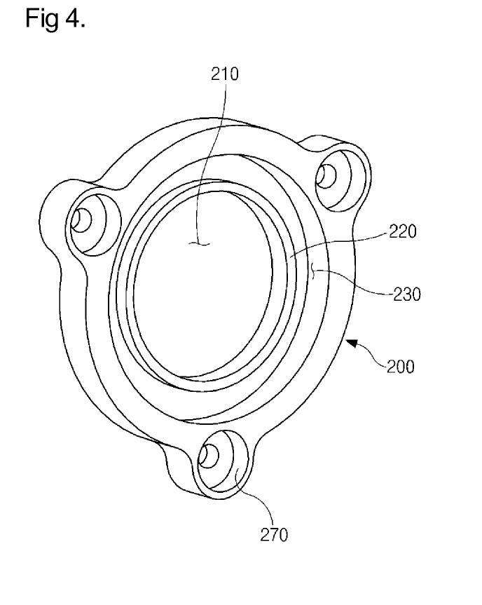

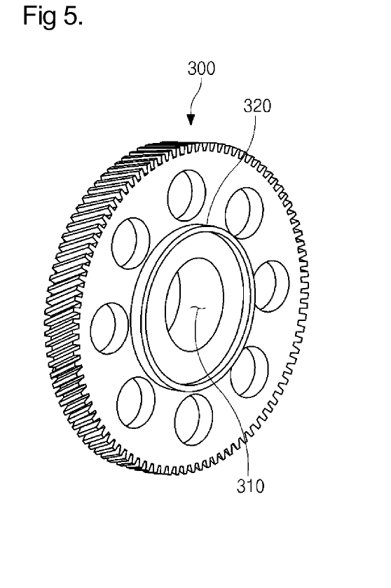

A guide plate mounting structure of a fuel pump according to an exemplary embodiment of the present invention may include a fuel pump 100 having a driving shaft and a housing 110 formed therein, a block 130 and a guide plate 200 inserted into the housing 110, and a fuel pump gear 300 inserted into the driving shaft 120, as shown in FIGS. 2 to 5.

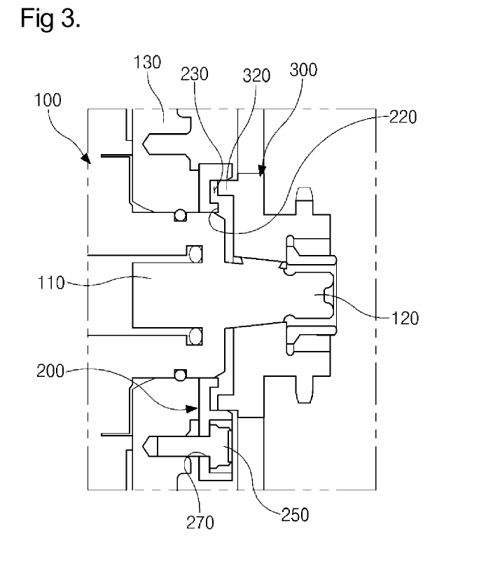

As shown in FIGS. 2 and 3, the fuel pump 100, which is mounted in a fuel tank to supply a fuel in the fuel tank to an engine, has the housing 110 of a cylindrical shape formed at one end thereof so as to be protruded, where the housing 110 has the driving shaft 120 formed at one end thereof so as to be protruded, with the driving shaft 120 being rotatably provided.

The block 130 has a ring shape and is inserted into an outer peripheral surface of the housing 110 of the fuel pump 100.

As shown in FIGS. 2 to 4, the guide plate 200 has a ring shape having a first through hole 210 formed at the center thereof and is inserted into the outer peripheral surface of the housing 110 of the fuel pump 100.

In this case, since the housing 110 of the fuel pump 100 has the block 130 inserted thereinto, the guide plate 200 is positioned at one end of the block 130 and is inserted into an end of the housing 110 of the fuel pump 100.

As such, the block 130 as well as the guide plate 200 are assembled and mounted in the housing 110 protruded from the fuel pump 100, such that tolerance occurrence of the housing 110 is decreased, thereby preventing noise from being generated.

As shown in FIGS. 2 to 5, the fuel pump gear 300 has a circular gear shape having a second through hole 310 formed at the center thereof and is inserted into the driving shaft 120 of the fuel pump 100. In this case, an inner diameter portion of the fuel pump gear 300 is inserted into the driving shaft 120 and an outer diameter portion thereof is connected to a chain.

The fuel pump gear 300 has a rim 320 protrudedly formed on one end surface thereof so as to be inserted into one end of the guide plate 200 inserted into the housing 110, thereby improving coupling force between the fuel pump gear 300 and the guide plate 200. As a result, it is possible to prevent the fuel pump gear 300 from being separated at the time of driving the driving shaft 120.

In this case, the first through hole 210 of the guide plate 200 has a step 220 formed along an inner peripheral surface thereof and the step 220 of the first through hole 210 and one end surface of the guide plate 200 has a circular insertion groove 230 formed therebetween, such that the rim 320 of the fuel pump gear 300 is inserted into the insertion groove 230 of the guide plate 200 at the time of coupling the guide plate 200 to the fuel pump gear 300.

As a result, even though chain tension is applied along the fuel pump gear 300, the coupling force between the fuel pump gear 300 and the guide plate 200 may be improved and deformation of the driving shaft 120 may be prevented by the rim 320 of the fuel pump gear 300 inserted into the insertion groove 230 of the guide plate 200.

In an exemplary embodiment of the present invention, the guide plate 200 includes a third through hole 270 and the block 130 is coupled to the guide plate 200 by a coupling member 250 that passes through the third through hole 270 of the guide plate 200 and is connected to the block 130.

As such, according to the exemplary embodiment of the present invention, the block 130 and the guide plate 200 are inserted into the housing 110 of the fuel pump 100 and the fuel pump gear 300 is inserted into the driving shaft 120 protruded from the housing 110, such that the housing 110 of the fuel pump 100 and the driving shaft 120 are coupled to the guide plate 200 and the fuel pump gear 300, thereby making it possible to decrease the tolerance and prevent the deformation of the driving shaft 120 to thereby decrease the noise generation.

As set forth above, according to the exemplary embodiment of the present invention, the guide plate is mounted in the fuel pump to decrease noise generation, such that engine productivity is improved and coupling force of the fuel pump, the block, the guide plate, and the fuel pump gear is improved, thereby making it possible to decrease tolerance occurrence to increase operability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A guide plate mounting structure of a fuel pump, the guide plate mounting structure comprising:
a fuel pump having a housing;
a driving shaft protrudedly formed from the housing to the outside of the fuel pump;
a block mounted onto an outer peripheral surface of the housing of the fuel pump;
a guide plate having a first through hole formed at a center thereof and being positioned at an end of the block; and
a fuel pump gear having:
a second through hole formed at a center thereof and being mounted to the driving shaft of the fuel pump through the second through hole; and
a rim formed on an end surface of the fuel pump gear so as to be inserted into a first end surface of the guide plate.

2. The guide plate mounting structure of the fuel pump according to claim 1,
wherein the first through hole of the guide plate has a step formed along an inner peripheral surface thereof and the step of the first through hole and the first end surface of the guide plate have a circular insertion groove formed therebetween, such that the rim of the fuel pump gear is inserted into the insertion groove.

3. The guide plate mounting structure of the fuel pump according to claim 1,
wherein the guide plate includes a third through hole, and
wherein the guide plate is connected to the block by a coupling member passing through the third through hole and being coupled to the block.
